(19) United States
(12) Patent Application Publication
(10) Pub. No.: US 2010/0119672 A1
(43) Pub. Date: May 13, 2010

(54) FRUIT RIPENING PROCESS USING BAGGING AND COOLING

(76) Inventor: Avi Crane, Laguna Hills, CA (US)

Correspondence Address: STETINA BRUNDA GARRED & BRUCKER, 75 ENTERPRISE, SUITE 250, ALISO VIEJO, CA, 92656, US

(21) Appl. No.: 12/267,251

(22) Filed: Nov. 7, 2008

(51) Int. Cl. A23B 5/04

(52) U.S. Cl. 426/419

(57) ABSTRACT

A method of handling fruit at ambient temperature is provided using bagging and cooling for prolonged storage and ripening of fruit. The type of fruit that is contemplated with respect to the method is a fruit having an internal fruit seed. The method begins by enclosing the fruit within a plastic packaging material to produce an enclosed fruit. The method continues with the enclosed fruit being exposed to an air flow. The enclosed fruit is exposed to the air flow until the internal fruit cools to a first cool temperature. The fruit is transferred from a surrounding environment at an ambient temperature to a surrounding environment which allows the internal fruit seed to cool to the first cool temperature. The internal fruit seed cools from the ambient temperature to the first cool temperature within a cool-down period. The method may conclude with the fruit being maintained at the first cool temperature of the internal fruit seed for a storage period.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates to a fruit ripening process and, more particularly, a fruit ripening process using bagging and cooling.

2. Description of the Related Art

Fruit ripening is a process associated with the edibility of fruit. A fruit may become sweeter, less green, and softer as it ripens. The life stages of a fruit are influenced by hormones. An organic compound involved with ripening in fruit is ethylene. Ethylene is a gas created by plants from the amino acid methionine. In fruit and fresh cut produce, ethylene gas increases the intracellular levels of certain enzymes. In small quantities, ethylene gas may be used as an anesthetic agent for expediting the fruit ripening process. Ethylene may act physiologically as a hormone in fruits. Ethylene exists naturally as a gas and may act at trace levels throughout the life of the fruit by stimulating or regulating the ripening of fruit. The ability to inhibit or control the production of ethylene gas by the fruit may be used to increase or decrease the period of time required for the natural ripening process.

The climacteric period in fruit corresponds with maximum cell respiration and ethylene production throughout the fruits life cycle. The climacteric period is the final physiological process that marks the end of fruit maturation and the beginning of fruit senescence. The climacteric period is the defining point associated with increased cell respiration of the fruit and normally takes place without any external influences. Subsequently, the fruits cell respiration rate may return to or below previous levels. The respiration rate of the fruit is associated with carbon dioxide production of the fruit. The climacteric period may also lead to other changes in the fruit including pigment changes and sugar release. For those fruits raised as food the climacteric period marks the peak of edible ripeness, with fruits having the best taste and texture for consumption. After this period, fruits are more susceptible to fungal invasion and begin to degrade with cell death. Therefore, both a delay in reaching the climacteric period and the extension of the climacteric period once reached may be desirable qualities during the fruit ripening process. Apples, avocados, bananas, melons, apricots, and tomatoes by way of example are climacteric fruit.

Many fruits are picked prior to full ripening because ripened fruits do not ship well. For example, bananas are picked when green and may artificially ripen after shipment by being exposed to ethylene gas. Another method used to artificially ripen fruit may include covering a bed of fruit and a few small open containers of calcium carbide with a plastic covering. The moisture in the air reacting with the calcium carbide releases the gas acetylene. Acetylene may have the same effect on the fruit as exposure to ethylene gas. Calcium carbide once dissolved in water produces acetylene which is an essential gas for the fruit ripening process. However, calcium carbide may contain traces of arsenic and phosphorus. The traces of arsenic and phosphorus, may pose a health risk. Due to possible health concerns, calcium carbide may not be recommended for the fruit ripening process. Acetylene is believed to affect the nervous system by reducing oxygen supply to the brain.

Another well known method for synthetically enhancing edibility of fruit is based on 1-methylcycolpropene (1-MCP). 1-MCP's mode of action is via a preferential attachment to the ethylene receptor, thereby blocking the effects of both endogenous and exogenous ethylene. It is applied in storage facilities and transit containers to slow down the ripening process and the production of the ethylene in fruit. Ethylene gas is not useful for ripe post harvested fruit. This method may be used to inhibit ripening of fruit by even a year. The delay of fruit ripening by approximately one year may result in consumers eating year-old fruit without being aware of it. The use of 1-MCP may be associated with a decline in vitamin C and antioxidant levels. With increased public awareness, the demand for organic fruit is increasing.

Using ethylene in the fruit ripening process is known as pre-conditioning the fruit. Pre-conditioning is the process of exposing firm/hard un-ripened fruit to ethylene gas to stimulate ripening. The benefits associated with pre-conditioning and controlled ripening may include increased sales, creation of impulse sales at retail store level, improve inventory control, regulate the period at which the fruit is ready to eat, produce consistent uniformly ripened fruit, and provide better control of quality and ripeness.

The pre-conditioning process may be used to stimulate ripening of avocados. The avocados are received and handled at a warehouse at ambient temperature having a corresponding avocado pulp temperature which may also be referred to as an internal fruit seed temperature. The avocado may then be placed in a controlled temperature environment for achieving a desired pulp temperature. The controlled temperature environment may use equipment capable of increasing and decreasing the pulp temperature of the avocado within a particular temperature range within a specified period of time. Avocados may produce 2-3 times more heat than bananas and thus stand to benefit from improved air circulation. Forced air cooling systems may result in the optimal heating and cooling of the avocado to the desired pulp temperatures. The air flow rate may be approximately 0.5 cubic feet per minute for every 16 avocados in the controlled temperature environment.

Proper pre-conditioning/ripening procedures may begin with placing the avocado within the controlled temperature environment and increasing the pulp temperature of the avocado to a range between 15° C. and 20° C. Using an ethylene generator or bottled ethylene to maintain ethylene at 10-100 parts per million (PPM) throughout the entire conditioning cycle. Optimum relative humidity level may be between 90 and 95 percent. The pulp temperature of the avocado may be cooled to 4° C.-6° C. to slow the ripening process. Warehouse storage of the pre-conditioned fruit at 4° C.-6° C. is recommended between 10 to 14 days. Older or stressed fruit may hold for less time resulting in irregular ripening and greater decay. After pre-conditioning, the ripened avocado is ready to be consumed. At 10° C. pulp temperature, the avocado may require between 7 and 10 days to ripen. At 15° C. pulp temperature, the avocado may require between 3 and 6 days to ripen. At 20° C. pulp temperature, the avocado may take between 2 and 4 days to ripen. The pre-conditioning/ripening process may be adjusted for non-forced air storage areas. Warehouse stacking may be implemented to improve the ripening process when forced air is not used. For example, the fruit may be stacked in an alternating four-block or five-block pattern resulting in adequate refrigeration and improved air circulation for controlling an increase in heat associated with the avocado.

Common causes of uneven ripening include improper amount of ethylene gas exposure, incorrect exposure time, ill-advised storage temperatures, and humidity levels below 85%. An increase in storage temperature resulting in pulp temperatures above 21° C. adversely affects the ripening process. In fact, a pulp temperature above 25° C. may block the ripening process. Improper air flow and circulation may cause hot spots within the fruit to develop. Additionally, excessive carbon dioxide buildup above 1% inhibits ripening of fruit. Excessive holding periods prior to beginning the ripening cycle, wide variation of pulp temperatures during arrival at the fruit packing warehouse and fruit stored below 6° C. before pre-conditioning may adversely impact the ripening process.

Accordingly, there exists a need in the art for an improved fruit ripening process using bagging and cooling which addresses one or more of the above or related deficiencies.

### BRIEF SUMMARY

A method of handling fruit at ambient temperature is provided using bagging and cooling for prolonged storage and ripening of fruit. The type of fruit that is contemplated with respect to the method is a fruit having an internal fruit seed. The method begins with enclosing the fruit within a perforated plastic packaging material to produce an enclosed fruit. The method continues with the enclosed fruit being exposed to an air flow. The enclosed fruit is exposed to the air flow until the internal fruit seed has a pulp temperature corresponding to a first cool temperature. In this regard, the fruit is transferred from a surrounding environment at an ambient temperature to a surrounding environment which allows the internal fruit seed to cool to the first cool temperature or remain at the first cool temperature. The first cool temperature may be substantially below the ambient temperature. The internal fruit seed cools from the ambient temperature to the first cool temperature within a cool-down period. The method may conclude with the fruit being maintained at the first cool temperature of the internal fruit seed for a storage period.

In another embodiment, the enclosed fruit may be placed within a vented storage container. After placing the enclosed fruit within the vented storage container, the enclosed fruit may be characterized as a packed bag fruit. The enclosed fruit is placed within the vented storage container prior to being exposed to the air flow. Placing the enclosed fruit within the vented storage container may increase the quantity of fruit to be transported while still allowing for adequate air flow to reach the packed bag fruit. In one embodiment, the fruit enclosed in the plastic packaging material are avocado. Because the fruit that may be enclosed within the plastic packaging material may be avocado, the plastic packaging material may be perforated. The perforation may allow for the optimal CO₂ atmosphere for preserving the fruit. The plastic packaging material may enclose a plurality of the fruit in accordance with the method described.

In another embodiment, the vented storage container may be arranged in a stacked configuration. The advantage associated is the ability to store a greater quantity of the packed bag fruit in the environment that may enable the internal fruit seed to reach the first cool temperature. The vented storage container may also include a plurality of layers to enable the storage of a greater quantity of packed bag fruit. One embodiment describes the air flow being produced by a forced air cooling system. If the forced air cooling system is used, then it may be configured to deliver between 2 and 3 cubic feet of air per minute per pound of fruit. A plurality of packed bag containers may be stored in bulk boxes. Forced air cooling may include exposing the bulk boxes of the packed bag fruit to a higher air pressure on side of the box. The unequal air pressure forces the cool air past the enclosed fruit, thereby increasing the cooling rate. The optimal humidity level associated with the forced air cooling may range between 90 and 95 percent.

In another embodiment, the first cool temperature is between 4 degrees Celsius and 6 degrees Celsius. In this regard, the environment in which the enclosed fruit is placed should be configured to enable the internal fruit seed temperature to cool from ambient temperature to the first cool temperature ranging between 4 and 6 degrees Celsius. The cool-down period associated with the time it takes the internal fruit seed temperature to cool from ambient temperature until the first cool temperature may be up to 48 hours. However, this assumes that forced air cooling is not used. Preferably, the cool down period may range between 6 and 12 hours when using forced air cooling. In further detail, the first cool temperature of the internal fruit seed may be maintained for a storage period of up to 45 days. However, it may be preferable for the storage period to last between 10 and 15 days. In the scenario where the fruit is an avocado, the subcutaneous compaction of the avocado is greater than 27 PSI during the storage period. The subcutaneous compaction may be measured using pentrometer.

The method may continue by exposing the enclosed fruit to an air flow until the internal fruit seed reaches a second cool temperature. The second cool temperature is between the ambient temperature and the first cool temperature. The environments in which the enclosed fruit are placed enable the internal fruit seed to increase in temperature from the first cool temperature to the second cool temperature. The second cool temperature may be maintained for a triggering period. The triggering period is induced subsequent to the storage period. In one embodiment, the second cool temperature is between 12 degrees Celsius and 14 degrees Celsius. The triggering period may last up to 48 hours. Maintaining the internal fruit seed at the second cool temperature for the triggering period of 48 hours may enable the fruit to uniformly turn to an expected color. For example, an avocado will turn black. A triggering period substantially less than 48 hours may risk the uniform color change involved during the triggering period. During the triggering period, the subcutaneous compaction of the enclosed fruit may be between 10 and 20 PSI.

In another embodiment, the method may continue with a ripening period following the triggering period. During the ripening period, the enclosed fruit is exposed to ambient temperature. The ambient temperature may vary between 15 degrees Celsius and 20 degrees Celsius. The ripening period may range between 48 hours and 96 hours. During the ripening period the subcutaneous compaction of the enclosed fruit is between 5 and 8 PSI. Following the ripening period, the enclosed fruit may be removed from the plastic packaging material and placed on a shelf for display for an extended shelf life. In the alternative, if the enclosed fruit must be shipped subsequent to the ripening period, the enclosed fruit may be shipped at a temperature ranging between 4 degrees Celsius and 6 degrees Celsius prior to being removed from the plastic packaging material and stored on a display shelf. It is preferable to avoid removing the enclosed fruit from the plastic packaging material prior to displaying the fruit on a shelf.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a method of post-harvest handling of fruit in accordance with the present invention;

FIG. 2 is a step by step example for storing and packing a plurality of fruit;

FIG. 3 is an aerial view of the packed fruit within a vented storage container; and

FIG. 4 is a perspective view of the packed fruit being exposed to an air flow for cooling the packed fruit.

### DETAILED DESCRIPTION

The above description is given by way of example, and not limitation. Given the above disclosure, one skilled in the art could devise variations that are within the scope of the invention disclosed herein, including various ways of handling post-harvest fruit at an ambient temperature. Further, the various features of the embodiments disclosed herein can be used alone, or in varying combinations with each other and are not intended to be limited to the specific combination described herein. Thus, the scope of the claims is not to be limited by the illustrated embodiments.

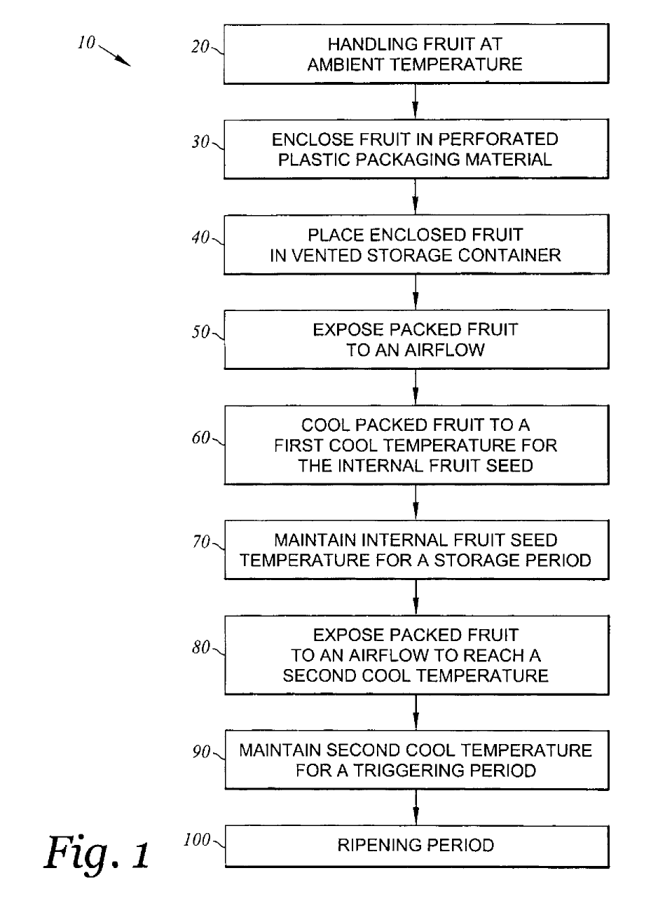

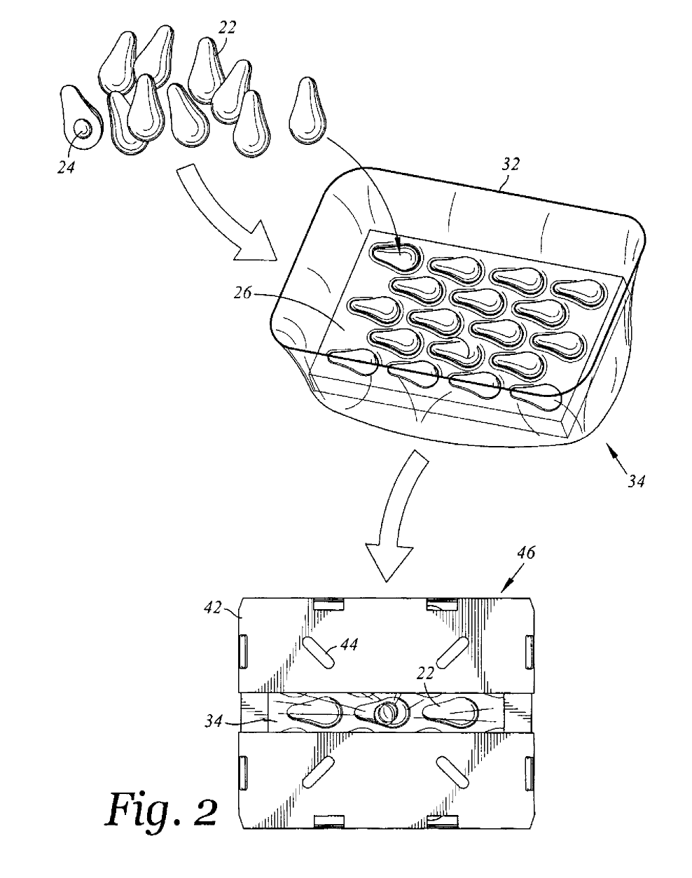

Referring now to FIG. 1, a flow chart illustrating a series of steps and procedures that may be used for post-harvest handling of a fruit 10. The first step 20 associated with the post-harvest handling of a fruit 10 includes handling fruit at an ambient temperature. With reference now to FIG. 2, the method may begin with receiving a fruit 22 at ambient temperature. In one embodiment, a plurality of the fruit 22 may be received at ambient temperature. The fruit 22 or plurality of the fruit 22 may include avocados. Avocados are a commercially valuable crop whose trees and fruit are cultivated in tropical and temperate climates throughout the world. The ambient temperature associated with the fruit 22 ranges depending upon the environment at which the fruit 22 was stored prior to being received. For example, if the fruit 22 is received from a refrigerated container, the ambient temperature may range between 3 degrees Celsius and 6 degrees Celsius. If the fruit 22 is transported directly from the field, the ambient temperature may be greater than 20 degrees Celsius. However, other ambient temperatures outside of this range are compatible with the post-harvest handling of the fruit 10 to extend the lifespan of the fruit 22 and reduce loss in quality associated with the fruit 22. Thus, the ambient temperature associated with the fruit 22 may vary depending upon the surrounding environment. Temperatures above 21 degrees Celsius may adversely affect the ripening process associated with the fruit 22. Temperatures above 25 degrees Celsius may prevent the ripening process of the fruit 22 entirely. The fruit 22 such as avocados may be received at ambient temperature from a local farmer, imported from a refrigerated container, or received for repacking by way of example only and not meant to limit the various ways in which the fruit 22 may be received.

The fruit 22 includes an internal fruit seed 24 as shown in FIG. 2. The internal fruit seed 24 has a temperature associated with it that may vary based upon the ambient temperature to which the fruit 22 was exposed. For example, if the fruit 22 is placed in a refrigerated container the internal fruit seed 24 temperature is cooler than the internal fruit seed 24 temperature of the fruit 22 transported directly from the field. The temperature of the internal fruit seed 24 may also be referred to as the pulp temperature. The pulp temperature of the fruit 22 is an important indicator that may correspond to optimal temperature ranges for preserving the fruit 22 and reducing loss in quality.

Referring back to FIG. 1, the second step 30 associated with the post-harvest handling of the fruit 10 includes enclosing the fruit in a perforated plastic packaging material. Subsequent to receiving the fruit 22, the fruit 22 may be placed on a tray 26. The tray 26 may be provided to facilitate the handling of a plurality of the fruit 22. However, the tray 26 is not required. The tray 26 with the fruit 22 is then placed in a perforated plastic packaging material 32. The perforated plastic packaging material 32 is used to bag the fruit 22 as provided in FIG. 2. In this regard, the perforated plastic packaging material 32 may include a bag. The bag may be sealed using a fastener or simply tied. Upon placement of the fruit 22 or the tray 26 of fruit 22 within the perforated plastic packaging material 32, the perforated plastic packaging material 32 may be sealed or tied to produce an enclosed fruit 34. The use of perforated plastic packaging material 32 for enclosing produce is provided in U.S. Pat. No. 6,190,710 issued to Nir et al. and incorporated by reference herein. The bag used to enclose the fruit 22 may have similar or identical properties in accordance with the plastic packaging material disclosed in the '710 patent. However, other perforated plastic packaging material 32 may also be used to enclose the fruit 22 and produce the enclosed fruit 34 inside the bag comprised of the perforated plastic packaging material 32. The perforated plastic packaging material 32 may not be limited to the plastic packaging material disclosed in the '710 patent.

The perforated plastic packaging material 32 may have a relatively high permeability to water vapor. The perforated plastic packaging material 32 may reduce condensation on the surface of the perforated plastic packaging material 32 when used to enclose or seal the fruit 22 or fruits therein. The composition of the perforated plastic packaging material 32 may include homopolymers, copolymers containing amides, esters, anhydrides, or urethanes, or their derivatives, or containing acyle groups, carboxyl groups, or alcohol groups, or their derivatives. The perforated plastic packaging material 32 may be micro-perforated to include very fine perforations. The amount of perforations may be increased or decreased to achieve a desired water vapor permeability level. In the example mentioned above for avocados, it may be preferable to use a perforated plastic packaging material 32 including micro-perforations having a diameter of less than 1 millimeter. The perforated plastic packaging material 32 allows for an increased percentage of carbon dioxide to exist within the perforated plastic packaging material 32 while minimizing condensation within. The environment within the perforated plastic packaging material enables reduced water loss associated with the fruit 22. Reduced water loss may preserve the quality of the fruit 22 for a longer time period. The perforated plastic packaging material 32 may absorb ethylene gas produced naturally by the internal fruit seed 24. Alternatively, the perforated plastic packaging material 32 may be configured to degrade ethylene gas produced naturally by the internal fruit seed 24. The characteristics or properties associated with a preferred plastic packaging material 32 may be determined by observing the sensitivity of the fruit 22 to carbon dioxide and the presence of water condensation. Additionally, by controlling the thickness of the perforated plastic packaging material 32 an optimal level of humidity within the perforated packaging material 32 may be achieved.

Placing the fruit 22 within the perforated plastic packaging material 32 before exposing the fruit 22 to a temperature controlled environment having a cooler ambient temperature than the pulp temperature of the internal fruit seed 24 reduces the likelihood of excess condensation. If the fruit 22 and consequently the internal fruit seed 24 are exposed to a temperature that is lower than the pulp temperature prior to being placed in the perforated plastic packaging material 32, a possible result may include extensive condensation that is not desired and may possibly harm or damage the fruit 22. Enclosing the fruit 22 within the perforated plastic packaging material 32 enables the control of moisture and gas composition of the environment in which the fruit 22 is maintained. The control of moisture and gas may facilitate a delay in the ripening process, preservation of the fruit 22, quality, and increased shelf-life. Additionally, the post-harvest handling of the fruit 10 does not require the pre-cooling of the fruit 22 prior to placement within the perforated plastic packaging material 32. This may result in substantial energy savings. Although pre-cooling the fruit 22 is not required, pre-cooling may be used. For example, when the fruit 22 is transported in a refrigerated container this may be a form of pre-cooling. The fruit 22 may experience a loss in quality between the period when the fruit 22 is harvested and the fruits 22 final destination such as a store shelf. The loss in quality of the fruit 22 may be unavoidable. However, loss in quality may be reduced according to the method provided. The fruit 22 is placed within the perforated plastic packaging material 32 and then placed in a controlled temperature environment. The controlled temperature environment is used to set the pulp temperature of the internal fruit seed 24. This method of post-harvest handling of fruit 10 delays the decay of the fruit 22 while attempting to preserve the quality. The avocado may contain up to 80% water when it is harvested. Furthermore, because the avocado has high respiration rates, and releases carbon dioxide and ethylene, the avocado degrades at a high rate with internal and irreversible changes. Thus, reducing dehydration of the avocado preserves the quality of the avocado.

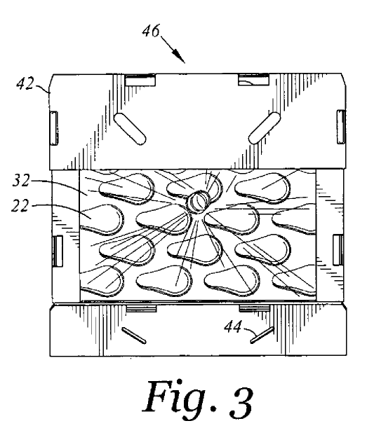

Following the step 30 of enclosing the fruit within the perforated plastic packaging material 32, the next step 40 provides that the enclosed fruit 34 is placed in a vented storage container 42 to produce a packed fruit 46 as provided in the third step 40 of the flow chart in FIG. 1 and shown in FIGS. 2 and 3. The vented storage container 42 may be configured from a variety of materials including but not limited to wood, plastic, and/or cardboard. However, other types of material may be used in accordance with the post-harvest handling of the fruit 10. The vented storage container 42 may facilitate ventilation to the enclosed fruit 34 stored therein. The vented storage container 42 may enable the transportation of a plurality of the fruit 22 from a first location to a second location. The vented storage containers 42 may also receive a plurality of the enclosed fruit 34 in one vented storage container 42. The vented storage container 42 may include a plurality of vent 44 openings that facilitate the exposure of the packed fruit 46 to an air flow.

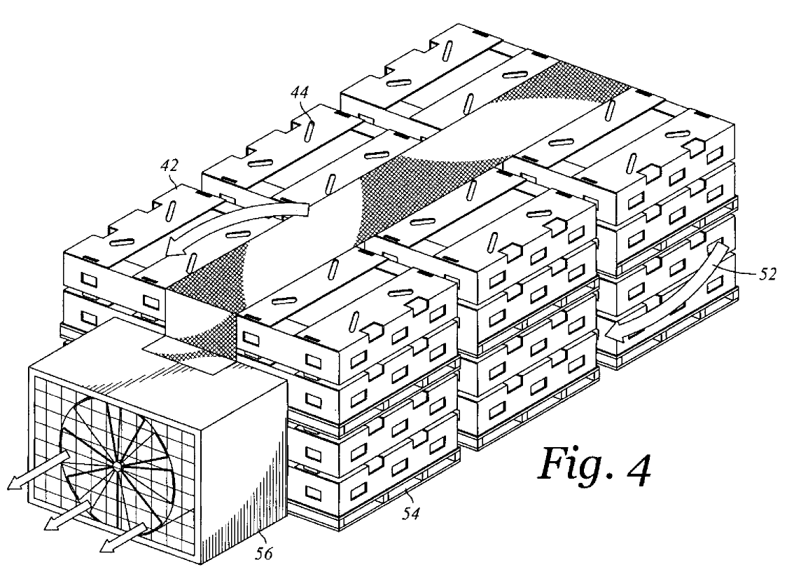

Referring now to FIGS. 1 and 4, the fourth step 50 provided in the flow chart requires the packed fruit 46 to be exposed to an air flow 52. The placing of the enclosed fruit 34 within the vented storage container 42 enables the packed fruit 46 to be exposed to the air flow 52. The air flow 52 may pass through the vented storage containers 42 that contain the enclosed fruit 34. The vented storage container 42 enable the fruit 22 to cool down from ambient temperature to a first cool temperature associated with the internal fruit seed 24. Exposing the packed fruit 46 to the air flow 52 may increase the life span of the fruit 22 by reducing dehydration with respect to the fruit 22.

The fruit 22 may need energy from the food reserves it stores. This process is called cell respiration. Heat energy is released during cell respiration. For the fruit 22 such as avocado, the internal avocado seed releases a substantial amount of heat energy during respiration. Exposing the fruit 22 to the air flow 52 and cooling the internal avocado seed to the first cool temperature reduces the heat energy released during cell respiration and thus prolongs the lifespan of the avocado. Further, cooling the internal avocado seed reduces the rate of ethylene production, moisture loss, spread of microorganisms, and deterioration from bruising. In addition, because the avocado was placed in the perforated plastic packaging material 32 prior to being exposed to the air flow 52, the conditions within the perforated plastic packaging material 32 while cooling to the first cool temperature enable the reduction of the cell respiration rate.

The air flow 52 may be generated by a forced air cooling system that includes a fan 56. The forced air cooling system creates an environment where the temperature of the internal fruit seed 24 of the packed fruit 46 is cooled from ambient temperature to the first cool temperature within a cool down period according to step five 60 as shown in FIG. 1. The cool down period may last between 6 and 12 hours when using forced air cooling. However, other known cooling techniques may be used to facilitate the method described herein. The cool down period for the packed fruit 46 may last up to 48 hours when other cooling techniques are used. Any cooling technique that requires a cool down period greater than 48 hours to reach the first cool temperature for the internal fruit seed 24 is not recommended. If the cool down period lasts longer than 48 hours, the quality of the fruit 22 or the shelf life may be adversely affected. The first cool temperature may range between 4 and 6 degrees Celsius. This temperature range applies to the pulp temperature or the internal fruit seed 24 temperature and not to the outer layer of the fruit 22 or the surrounding environment.

The following step 70 provides for the internal fruit seed 24 temperature to be maintained for a storage period. Following step 60 of cooling the internal fruit seed to the first cool temperature, the packed fruit 46 is stored for a period of time while maintaining the first cool temperature associated with the internal fruit seed 24. In this regard, the controlled temperature environment must be sufficiently cool to maintain the first cool temperature associated with the internal fruit seed 24. In one embodiment, the recommended storage period for the packed fruit 46 ranges between 10 and 15 days. As a result, the internal fruit seed 24 temperature remains at the first cool temperature for a period of 10 to 15 days. However, the packed fruit 46 may be stored for a period of up to 45 days with the internal fruit seed 24 temperature in the range of the first cool temperature without significantly affecting the quality of the fruit 22.

The packed fruit 46 may be exposed to an air flow 52 for increasing the internal fruit seed 24 temperature according to next step 80. The internal fruit seed temperature 24 is increased from the first cool temperature to a second cool temperature. The second cool temperature may be between the first cool temperature and the ambient temperature at which the fruit 22 was received. The initiation of the increase in temperature from the first cool temperature to the second cool temperature marks the start of a triggering period 90 provided in the following step 90. During the triggering period 90 it may be critical to have optimal air circulation around the packed fruit 46. The triggering period 90 may last up to 48 hours. In other words, the internal fruit seed 24 temperature of the packed fruit 46 is maintained at the second cool temperature. The second cool temperature may range between 12 degrees Celsius and 14 degrees Celsius. The result of requiring the triggering period 90 to last approximately 48 hours enables the outer portion or peel of the fruit 22 to change color in a uniform manner. If the packed fruit 46 is in the triggering period 90 for a time substantially less than 48 hours it may result in non-uniform change of color and possibly other internal deficiencies associated with the quality of the fruit 22. Conversely, if the triggering period 90 is maintained past the 48 hours, the shelf life of the packed fruit 46 upon removal from the perforated plastic packaging material 32 may be reduced. The triggering period 90 may prepare the fruit 22 for the ripening process.

Following the triggering period 90, is a ripening period 100. During the ripening process the packed fruit 46 may be exposed to an ambient temperature. Typically the ambient temperature that the packed fruit 46 is exposed to for the ripening period 100 may range between 15 degrees Celsius and 20 degrees Celsius for proper storage of the packed fruit 46. The ripening period 100 for the fruit 22 may range between 48 hours and 96 hours. During this time the internal fruit seed 24 temperature may increase. After the ripening period 100 is completed the packed fruit 46 may be removed from the vented storage containers 42. The enclosed fruit 34 may also be removed from the perforated plastic packaging material 32 and displayed for sale. In some cases, after the ripening period 100 is completed, the packed fruit 46 may require shipping to reach the desired destination for the sale or consumption of the fruit 22. In this regard and in accordance with industry standards, the packed fruit 46 may be shipped while cooling the internal fruit seed 24 temperature from ambient level to the first cool temperature range between 4 and 6 degrees Celsius. The shipping period may last between 48 and 96 hours. Upon the fruit's 22 arrival to the final destination, the enclosed fruit 34 may remain in the perforated plastic packaging material 32 until the fruit 22 is ready to be displayed.

If the fruit 22 that is handled post-harvest is an avocado, there are important parameters associated with each stage of the post-harvest handling of the fruit 10. When the avocado is picked from its tree it is in an un-ripened stage wherein the exterior may be very hard. Typically, the pressure is greater than 27 pounds per square inch (PSI). As a result, the subcutaneous compaction of the avocado prior to being enclosed within the perforated plastic packaging material 32 and subsequently the vented storage container 42 may be greater than 27 PSI. During the storage period when the enclosed avocado's internal fruit seed 24 temperature is cooled from ambient temperature to the first cool temperature, the subcutaneous compaction of the avocado should remain greater than 27 PSI. After the storage period, the enclosed avocado begins a triggering period 90 in accordance with the method provided. During the triggering period, the subcutaneous compaction of the avocado decreases. In other words, the exterior of the avocado softens. At this stage the subcutaneous compaction may range between 10 and 20 PSI. Although the subcutaneous compaction has decreased, at this stage the avocado may still be considered to have a hard exterior that is not ready for consumption. Following the triggering period 90 the avocado begins to ripen during the process known as the ripening period 100. The exterior of the avocado begins to soften. The subcutaneous compaction may range between 5 and 8 PSI throughout the ripening period 100. If the avocados are to be shipped to the desired location, the avocados may be shipped in refrigerated containers that allow for the subcutaneous compaction of the avocado to remain generally constant during shipping, namely, between 5 and 8 PSI. Upon removal of the avocados from the perforated plastic packaging material 32 after either the ripening process or the shipping process, the subcutaneous compaction of the avocados should be less than 5 PSI. The avocados are ready for consumption when the subcutaneous compaction is below 5 PSI.

The method of post-harvest handling of fruit 10 that is provided is advantageous because of the flexibility associated with the various processes. The method is flexible with respect to where and who may facilitate the handling of the fruit 22 in accordance with the method described. In one example, the entire method may be undertaken by a fruit packinghouse. In this scenario, the packinghouse receives the fruit 22 at an ambient temperature. Upon receiving the fruit 22, the fruit 22 is enclosed in the perforated plastic packaging material 32 and then stored in a controlled temperature environment so that the internal fruit seed 24 temperature is either cooled to or maintained at the first cool temperature. In one embodiment, the fruit 22 may be enclosed immediately in the perforated plastic packaging material 32. However, in another embodiment, the fruit 22 received by the packinghouse may go through a quality inspection process or other well know processes associated with industry standards prior to being enclosed within the perforated plastic packaging material 32. The storage period of the enclosed fruit 34 at the first cool temperature may be completed at the packinghouse. Additionally, the triggering period 90 and the ripening period 100 may be completed at the packinghouse. After the ripening period 100 is completed at the packinghouse, the fruit 22 may be removed and displayed for sale or shipped to a particular location prior to removal from the perforated plastic packaging material 32.

In another example, the post-harvest handling of fruit 10 provided may be accomplished by a shipping company or a separate entity from the packinghouse. In this example, upon picking of the fruit 22 from the field, the fruit 22 may be enclosed in the perforated packaging material 32 prior to cooling the internal fruit seed 24 to the first cool temperature. The enclosed fruit 34 may be stored in a vented storage container 42 for the storage period at the first cool temperature. The triggering period 90 may then be initiated during shipping assuming that there is adequate airflow. The ripening period 100 may then be initiated and completed after shipping of the enclosed fruit 22. There are a variety of combinations in which the handling of the fruit 10 may be accomplished by a single entity or multiple entities.

The method of handling fruit that is provided may reduce the cost significantly of handling fruit in comparison to industry standards. Enclosing the fruit 22 in the perforated plastic packaging material 32 allows for the control of temperature and atmosphere within the perforated plastic packaging material 32. The perforated plastic packaging material 32 enables the fruit 22 to produce its own ethylene gas naturally at optimal conditions. There is no need for the use of ethylene gassing rooms. The savings associated with not requiring ethylene gassing may be substantial. Using the method provided also enables added flexibility and control with respect to when the fruit 22 may be displayed. Upon receiving the fruit 22, the customer may have the option to hold the enclosed fruit 22 in a controlled temperature environment for up to three days. The method facilitates uniform ripening of the fruit 22 partly because the perforated plastic packaging material 32 produces the optimal balance between dioxide and carbon dioxide, creating the conditions for uniform fruit ripening during the storage period, the triggering period, and the ripening period. Uniform fruit ripening may prevent or reduce checker boarding and discoloration. Another added benefit is the ability to consolidate shipments of fruit and adjusting to the variations associated with retail demand.

The post-harvest handling of fruit 10 through the storage of fruit 22 in perforated plastic packaging material 32, then cooling during a storage period, triggering period, and finally a ripening period preserves the fresh flavor of the fruit 22 and the nutritional value. The modified atmosphere and humidity also reduces dehydration and weight loss, which in turn preserves firmness and prevents shrinkage of the fruit 22. The condensation associated with the fruit 22 is reduced which may inhibit the growth of pathogens. Condensation is reduced by achieving proper humidity levels within the perforated plastic packaging material 32, allowing excess moisture to escape. This process allows the shelf life to be extended while maintaining the internal and external quality of the fruit 22. Subsequently, ripening may be induced by triggering the fruit 22 with a change in temperature. The method allows the enclosed fruit 22 to naturally create the optimal atmosphere for ripening that is triggered by temperature changes at the appropriate time. The storage life of the enclosed fruit 22 may be extended between 45 and 60 days, without significant chilling injury, internal fruit disorder, or external fruit disorder. Normal fruit ripening may occur after removal from the bag at ambient temperature of approximately 20 degrees Celsius. Ripening of the fruit 22 without using the method provided may result in non-uniform ripening and considerable weight loss in the fruit 22. In the event where fruit is not handled according to the method, a high incidence of pulp discoloration and Anthracnose decay may exist after 30 days of storage.

What is claimed is:

1. A method of post-harvest handling a fruit at an ambient temperature, the fruit having an internal fruit seed, the method comprising:
enclosing the fruit within a perforated plastic packaging material to produce an enclosed fruit;
placing the enclosed fruit within a vented storage container to produce a packed fruit;
exposing the packed fruit to an air flow until the internal fruit seed has a first cool temperature between 4 degrees Celsius and 6 degrees Celsius within a cool-down period not exceeding 48 hours from exposure of the packed fruit to the air flow; and
maintaining the packed fruit in a controlled temperature environment between 4 degrees Celsius and 6 degrees Celsius for a storage period not exceeding 45 days.

2. The method of claim 1, wherein the internal fruit seed temperature is maintained at the first cool temperature for a storage period not exceeding 45 days.

3. The method of claim 1, wherein the packed fruit is exposed to an air flow until the internal fruit seed reaches a second cool temperature between the ambient temperature and the first cool temperature, the second cool temperature being maintained for a triggering period.

4. The method of claim 3, wherein the second cool temperature is between 12 degrees Celsius and 14 degrees Celsius.

5. The method of claim 3, wherein the triggering period does not exceed 48 hours.

6. The method of claim 3, wherein the packed fruit is exposed to an ambient temperature, the ambient temperature being maintained for a ripening period.

7. The method of claim 6, wherein the ambient temperature ranges between 15 degrees Celsius and 20 degrees Celsius.

8. The method of claim 6, wherein the ripening period is between 48 hours and 96 hours.

9. The method of claim 1, wherein a subcutaneous compaction of the packed fruit is greater than 27 pounds per square inch (PSI) during the storage period.

10. The method of claim 3, wherein a subcutaneous compaction of the packed fruit is between 10 and 20 pounds per square inch (PSI) after the triggering period.

11. The method of claim 6, wherein a subcutaneous compaction of the packed fruit is between 5 and 8 pounds per square inch (PSI) after the ripening period.

12. The method of claim 1, wherein the fruit is an avocado.

13. The method of claim 1, wherein a plurality of the fruit are enclosed in the perforated plastic packaging material.

14. The method of claim 1, wherein a plurality of vented storage containers are arranged in a stacked configuration.

15. The method of claim 1, wherein the vented storage container comprises of a plurality of layers.

16. The method of claim 1, wherein the air flow is produced by a forced air cooling system.

17. The method of claim 16, wherein the forced air cooling system is configured to deliver between 2 and 3 cubic feet of air per minute per pound of the fruit.

18. The method of claim 1, wherein a preferred cool-down period ranges between 6 hours and 12 hours.

19. The method of claim 1, wherein a preferred storage period ranges between 10 days and 15 days.

20. The method of claim 1, wherein the perforated plastic packaging material is a bag.
